(19) United States
(12) Patent Application Publication
(10) Pub. No.: US 2007/0107636 A1
(43) Pub. Date: May 17, 2007

(54) Removable solvent based paint formulation and system

(76) Inventor: Donald Warren, Carrollton, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/599,569

(22) Filed: Nov. 14, 2006

Related U.S. Application Data
(60) Provisional application No. 60/736,487, filed on Nov. 14, 2005.

(51) Int. Cl. C08K 5/00

(52) U.S. Cl. 106/499

(57) ABSTRACT

A removable lacquer coating or paint of approximately 20 to 30% by weight of cellulose acetate butyrate, 50 to 80% by weight of alcohol and 10 to 30% by weight of diacetone alcohol is provided. It may also contain from 1 to 7% sucrose acetate isobutyrate. This removable paint can be removed by a formulation of diacetone alcohol, ethyl alcohol, hydroxypropylcellulose and a surfactant.

### CROSS-REFERENCE TO RELATED APPLICATION

This application claims priority to copending U.S. provisional application entitled, “A Removable Paint Formulation and System,” having Ser. No. 60/736,487, filed Nov. 14, 2005, which is entirely incorporated herein by reference.

### TECHNICAL FIELD

This invention relates to a solvent based coating or paint that can be easily removed by certain remover compositions without damaging the underlying paint or coating. This coating is basically a combination of cellulose acetate butyrate alcohol and diacetone alcohol. Pigment can be added to the coating to make it a paint.

### BACKGROUND OF THE INVENTION

It is many times desirable to have a solvent based coating or paint formulation that can be applied over another paint or substrate and subsequently removed without damaging the underlying paint or substrate. This is difficult to accomplish because the solvents that will remove the paint that it is intended to remove may also remove the underlying paint or damage its luster. This type of application of a removable paint would be desirable for automobile signs or signs with temporary colors.

### SUMMARY OF THE INVENTION

An easily removable solvent based coat or paint is provided by this invention. This paint is a lacquer formulation of approximately 20 to 30% by weight of cellulose acetate butyrate, 50 to 80% by weight of alcohol and 10 to 30% by weight of diacetone alcohol. Preferably approximately 23% by weight of cellulose acetate butyrate is used, 58% by weight of alcohol and 18.5% by weight of diacetone alcohol. For screen printing from 1 to 7% of sucrose acetate isobutyrate may be used. This coating may include a pigment which makes it into a paint.

A remover formulation is provided which is a mixture of diacetone alcohol, ethyl alcohol, hydroxypropylcellulose and a surfactant. The remover formulation is simply sprayed or brushed onto the removable paint and agitated with a sponge or brush and wiped off with a towel or washed away with water. This removable paint can be used on an automobile to form a clear coating or can be used as temporary paint for painting over a painted or unpainted surface and then easily removing it when it is desired to remove the temporary coating.

### DETAILED DESCRIPTION OF THE PREFERRED EMBODIMENT

An easily removable solvent based coating or paint is provided by this invention. This coating is basically a lacquer. This removable or temporary coating or paint can be easily removed by certain remover formulations.

The lacquer formulation consists of approximately 20 to 30% by weight of cellulose acetate butyrate, 50 to 80% by weight of alcohol and 10 to 30% by weight of diacetone alcohol. Preferably approximately 23% by weight of cellulose acetate butyrate is used, 58% by weight of alcohol and 18.5% by weight of diacetone alcohol. The alcohol may be ethyl alcohol or denatured with a small amount of isopropyl alcohol (e.g. 5%).

This paint or coating can be made more compatible for screen printing by adding from 1 to 7% of sucrose acetate isobutyrate to this formulation. Preferably from 3% to 5% of sucrose acetate isobutyrate is added, while approximately 4% is preferred. Preferably this formulation contains approximately 22% by weight of cellulose acetate butyrate, 56% by weight of alcohol, 18% of diacetone alcohol, and 4% of sucrose acetate isobutyrate.

Pigment can be added to the mixture to make a paint in the normal manner. Typically, pigment in an amount from 6 to 22% by weight is added depending upon the pigment and other factors. Special effect particles can be added to add texture, or reflection characteristics to the coating or paint in the normal manner.

The removable paint of this invention can be applied by any conventional means such as spraying, brushing or screen printing. In the case of automobiles it is preferable to spray the paint on the automobile.

As a part of this system a remover formulation is provided. The preferred remover formulation is a mixture of diacetone alcohol, ethyl alcohol, hydroxypropylcellulose (as a viscosity modifier) and a surfactant/emulsifier (for water wash off).

The remover formulation is simply sprayed or brushed onto the removable paint and agitated with a brush or sponge for a few minutes and the residue wiped off with a towel or washed away with water. The system of this invention will not damage the underlying paint.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

### EXAMPLE I

An eight-gallon batch of the lacquer removable coating of this invention was made. Seven thousand grams of cellulose acetate butyrate (23.18% by weight) in powder form, Eastman Chemical CAB-553-0-4, was dissolved in 17,600 grams of a mixture of 95% ethyl alcohol and 5% isopropyl alcohol (58.28% by weight) and 5,600 grams of diacetone alcohol (18.54% by weight). This was spread on the lacquer finish of an automobile to form a clear coating.

This clear coating was removed by a remover which was a blend of diacetone alcohol 25% by weight, denatured alcohol 65% by weight, hydroxypropylcellulose, 5% by weight, and an emulsifying surfactant 5% by weight which was sprayed or brushed onto the removable paint, agitated with a sponge and allowed to set and then wiped with a towel for a few minutes. This removal did not damage the original painted surface to which the removable paint was applied.

### EXAMPLE 2

An eight-gallon batch of the lacquer removable coating of this invention was made by mixing the following ingredients. Seven thousand grams of cellulose acetate butyrate (22.29% by weight) in powder form, Eastman Chemical CAB-553-0-4, was dissolved in 17,600 grams of a mixture of 95% ethyl alcohol and 5% isopropyl alcohol (56.05% by weight) and 5,600 grams of diacetone alcohol (17.83% by weight) with 1200 grams of sucrose acetate isobutyrate (3.82%). This formulation was sprayed on the finish of an automobile to form a clear coating. The clear coating was removed by using the remover and procedure set forth in Example 1.

Therefore, having thus described the invention, at least the following is claimed:

1. A removable coating system comprising:
(a) a removable coating formulation comprising cellulose acetate butyrate, alcohol and diacetone alcohol; and
(b) a remover formulation of a blend of denatured alcohol, diacetone alcohol, hydroxypropylcellulose, and an emulsifying surfactant.

2. A removable coating system of claim 1 in which the cellulose acetate butyrate is present in the removable coating formulation in an amount of from 20 to 30% by weight of the coating formulation and the alcohol is present in an amount of from 50 to 80% of the coating formulation and the diacetone alcohol is present in an amount from 10 to 30% by weight of the coating formulation.

3. A removable coating system of claim 1 in which the alcohol in the removable coating formulation is an alcohol of from 2 to 3 carbon atoms.

4. The removable coating system of claim 1 in which the coating formulation also contains from 1 to 7% by weight of sucrose acetate isobutyrate.

5. A removable coating system of claim 1 in which the cellulose acetate butyrate is present in the removable coating formulation in an amount of approximately 23% by weight of the coating formulation and the alcohol in the coating formulation is a mixture of ethyl alcohol and isopropyl alcohol and is present in an amount of approximately 58% by weight and the diacetone alcohol in the coating formulation is present in an amount of approximately 18.5% by weight.

6. The removable coating system of claim 1 in which the removable coating formulation has cellulose acetate butyrate present in an amount of approximately 22% by weight, and the alcohol is present in an amount of 56% by weight and the diacetone alcohol is present in an amount of approximately 18% by weight and which also contains approximately 4% by weight of sucrose acetate isobutyrate.

7. The removable coating system of claim 1 in which the coating formulation also contains a dispersible pigment in an amount sufficient to achieve the desired color in the coating which makes it a paint.

8. The removable coating system of claim 2 in which the coating formulation also contains a dispersible pigment in an amount sufficient to achieve the desired color in the coating which makes it a paint.

9. The removable coating system of claim 6 in which the coating formulation also contains a dispersible pigment in an amount sufficient to achieve the desired color in the coating which makes it a paint.

10. The removable coating system of claim 1 in which the coating formulation also contains effect particles to achieve a special effect in the coating.

11. The removable coating system of claim 9 in which the coating formulation also contains effect particles to achieve a special effect in the painting.

12. A removable coating formulation comprising cellulose acetate butyrate, alcohol and diacetone alcohol.

13. The removable coating formulation of claim 12 in which the cellulose acetate butyrate is present in an amount of from 20 to 30% by weight of the formulation, and the alcohol is present in an amount from 50 to 80% by weight of the formulation and the diacetone alcohol is present in an amount from 10 to 20%.

14. The removable coating formulation of claim 12 in which the cellulose acetate butyrate is present in the removable coating formulation in an amount of approximately 23% by weight of the coating formulation and the alcohol in the coating formulation is a mixture of ethyl alcohol and isopropyl alcohol and is present in an amount of approximately 58% by weight and the diacetone alcohol in the coating formulation is present in an amount of approximately 18.5% by weight of the coating formulation.

15. A removable coating formulation of claim 12 in which the alcohol is an alcohol of from 2 to 3 carbon atoms.

16. The removable coating formulation of claim 12 which also contains a dispersible pigment.

17. The removable paint formulation of claim 12 which also contains sucrose acetate isobutyrate in an amount of from 1 to 7% by weight.

18. The removable coating formulation of claim 17 which also contains a dispersible pigment.

19. The removable coating formulation 12 in which the cellulose acetate butyrate is present in an amount of approximately 22% by weight, and the alcohol is present in an amount of 56% by weight and the diacetone alcohol is present in an amount of approximately 18% by weight and which also contains approximately 4% by weight of sucrose acetate isobutyrate.

20. The removable coating formulation of claim 19 which also contains a dispersible pigment.

21. A method for temporarily protecting a hard or sealed surface or an unpainted or painted article which comprises coating the surface of the article with the formulation of claim 12.

22. The method of claim 21 in which the cellulose acetate butyrate in the formulation is present in an amount of from 20 to 30% by weight of the formulation, and the alcohol is present in an amount from 50 to 80% by weight of the formulation and the diacetone alcohol is present in an amount from 10 to 20%.

23. The method of claim 21 in which the cellulose acetate butyrate in the formulation is present in an amount of approximately 23% by weight of the coating formulation and the alcohol in the coating formulation is a mixture of ethyl alcohol and isopropyl alcohol and is present in an amount of approximately 58% by weight and the diacetone alcohol in the coating formulation is present in an amount of approximately 18.5% by weight of the coating formulation.

24. The method of claim 21 in which the cellulose acetate butyrate in the formulation is present in an amount of approximately 22% by weight, and the alcohol is present in an amount of 56% by weight and the diacetone alcohol is present in an amount of approximately 18% by weight and which also contains approximately 4% by weight of sucrose acetate isobutyrate.

25. A method for temporarily protecting the surface of an unpainted or painted article and for removing such coating which comprises coating the surface of the article with the composition of claim 1 and removing the coating with the remover formulation of claim 1
